(19) United States
(12) Patent Application Publication
(10) Pub. No.: US 2013/0190929 A1
(43) Pub. Date: Jul. 25, 2013

(54) APPLIANCE CONSOLE WITH CONNECTOR-FREE ATTACHMENT TO APPLIANCE

(71) Applicants: Eric K. Larson, Glenview, IL (US); Jianhong Kang, Glenview, IL (US); Mathew C. Webster, Glenview, IL (US)

(72) Inventors: Eric K. Larson, Glenview, IL (US); Jianhong Kang, Glenview, IL (US); Mathew C. Webster, Glenview, IL (US)

(73) Assignee: ILLINOIS TOOL WORKS INC., Glenview (US)

(21) Appl. No.: 13/825,250

(22) PCT Filed: Oct. 4, 2011
(86) PCT No.: PCT/US2011/054788

§ 371 Date: Mar. 20, 2013

Related U.S. Application Data
(60) Provisional application No. 61/389,918, filed on Oct. 5, 2010.

(51) Int. Cl. G05B 15/02

(52) U.S. Cl. CPC G05B 15/02
USPC 700/275; 705/28

(57) ABSTRACT

A configuration system for an appliance such as a dryer or washing machine provides for multiple interchangeable consoles having different user controls and displays that may be attached to standardized appliance housings to change the functionality of the appliance allowing for multiple appliance styles to be offered with reduced inventory stocking requirements

### CROSS-REFERENCE TO RELATED APPLICATIONS

This application claims the benefit of U.S. provisional application 61/389,918 filed Oct. 5, 2010 hereby incorporated by reference.

### FIELD OF THE INVENTION

The present invention relates to household appliances such as dishwashers, washing machines and dryers and in particular to an appliance having interchangeable control consoles that may be attached to the appliance body to change the functionality of the appliance.

### BACKGROUND OF THE INVENTION

Many household appliances are offered in a variety of different styles and models to better match the needs and budgets of the consumer. Normally, higher end appliances offer additional features and functions. For example, an entry-level washing machine may provide for only a few different types of wash cycles (e.g. regular, permanent press, delicate, and soak) while a high-end washing machine may provide for many more cycles each providing different control of the agitator, water temperature, and timing of the operation of the appliance.

The variety of styles and models creates substantial inventory burdens on retailers who must stock many machines to permit immediate sales to customers. While different styles and models may share common components, reconfiguring the appliances on-site to take advantage of this commonality is beyond the capabilities of most retailers.

### SUMMARY OF THE INVENTION

The present invention provides an appliance that can accept a variety of different consoles within a model to permit different model styles to be created in the retail environment by matching different consoles to particular appliance bodies. This ability to interchange consoles in the retail environment is made possible by a simple, mechanical interconnection between the console and the appliance body in which both power and control data are communicated wirelessly avoiding the need for electrical interconnections that might be susceptible to damage, misconnection or moisture.

Specifically, the present invention may provide an appliance system having an appliance body providing a cabinet housing with at least one of electrical actuators and electrical sensors for implementing a function of the appliance and a first and second appliance console providing different user accessible controls implementing at least some different appliance functions, the appliance consoles interchangeably attaching to the appliance body. The appliance body supports at least one primary coil attached proximate to a location of an appliance console when an appliance console is attached to the appliance body, the primary coil attached to driving circuitry providing an oscillating magnetic field passing from the appliance body. The first and second appliance console each support at least one secondary coil attached proximate to the primary coil of the appliance body when the appliance console is attached to the appliance body, the secondary coils being electrically connected to receiving circuitry to rectify an alternating current signal induced in the secondary coil by the primary coil to provide the power to the appliance console.

It is thus a feature of at least one embodiment of the invention to eliminate the need for high-power electrical interconnection when attaching different consoles two different appliance bodies, for example at a point of retail.

The appliance system may further include a wireless transceiver pair positioned one in the console and one in the appliance body for transmitting and receiving the data respectively between at least one of the user accessible control and one of sensors and actuators in the appliance body.

It is thus a feature of at least one embodiment of the invention to allow consoles to be functionally attached to an appliance body with only mechanical interconnection by the worker.

The user accessible controls may be selected from the group consisting of: manually operated electrical switches and visual displays.

It is thus a feature of at least one embodiment of the invention to permit consoles having both or either of user actuation and user display features.

The primary and secondary coils may be planar coils having conductors confined substantially each to a single plane.

It is thus a feature of at least one embodiment of the invention to provide high-efficiency lightweight electrical interconnection by magnetic coupling.

The primary and secondary coils may be formed at least in part as traces in a printed circuit board.

It is thus a feature of at least one embodiment of the invention to provide a low-cost fabrication technique for planar electrical coils.

The appliance system may include a sensor controlling power transmitted from the primary coil according to whether a secondary coil is positioned nearby.

It is thus a feature of at least one embodiment of the invention to prevent undue heating of the primary coil in the absence of electrical coupling. By sensing electrical coupling, effectively greater power capacity may be obtained from a given coil size.

The primary and secondary coils may be separated from user contact by an electrical insulator when the appliance console is attached to the appliance body.

It is thus a feature of at least one embodiment of the invention to shield inexperienced users from electrical hazard. The use of electromagnetic coupling eliminates the need for exposed electrical connectors.

Other features and advantages of the invention will become apparent to those skilled in the art upon review of the following detailed description, claims and drawings in which like numerals are used to designate like features.

### BRIEF DESCRIPTION OF THE DRAWINGS

FIG. 1 is a perspective view of an example appliance having an appliance body and multiple consoles which may be connected to the appliance body to produce different styles within a model series, the views showing, in phantom, internal components of the appliance;

FIG. 2 is a fragmentary elevational cross-section through connecting faces of the appliance body and the console showing mechanical interconnection and wireless power and data connection using communication devices abutting when the appliance body and console are interconnected; and

FIG. 3 is a schematic block diagram of the appliance of FIG. 1.

FIG. 4 is a block diagram of the driving and receiving circuitry used for the efficient transmission of power between the appliance body and a console;

FIG. 5 is a cross-sectional view through a printed circuit board implementing a primary coil or secondary coil and showing an optional reinforcing metal form for increasing current capacity;

FIG. 6 is a simplified circuit schematic of the driving circuitry of FIG. 4;

FIG. 7 is a figure similar to that of FIG. 6 showing the receiving circuitry; and

FIG. 8 is a fragmentary phantom view of the appliance body and a console, similar to that of FIG. 1, showing coils constructed of discrete windings of electrical wire in an alternative bracket attachment of the console.

Before the embodiments of the invention are explained in detail, it is to be understood that the invention is not limited in its application to the details of construction and the arrangement of the components set forth in the following description or illustrated in the drawings. The invention is capable of other embodiments and of being practiced or being carried out in various ways. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof.

### DETAILED DESCRIPTION OF THE PREFERRED EMBODIMENTS

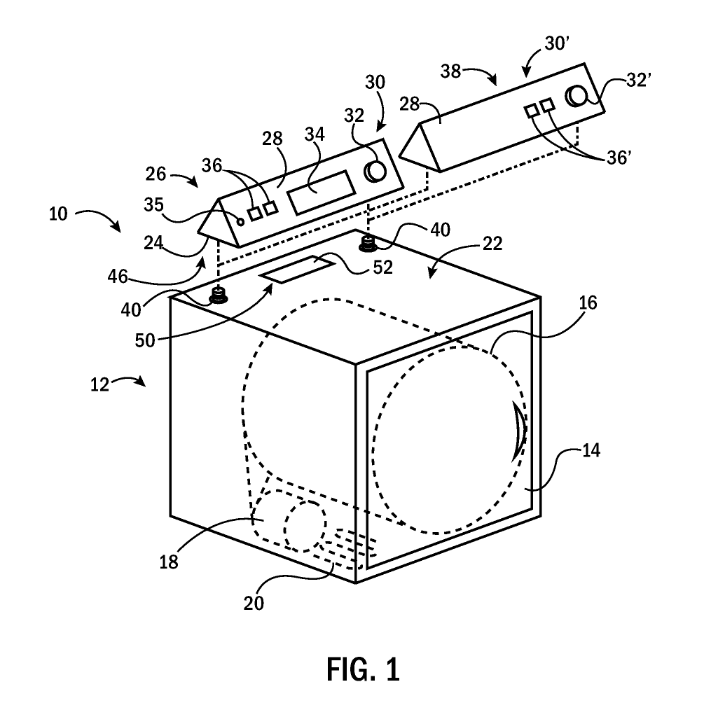

Referring now to FIG. 1, an appliance 10, such as a washer, dryer, dishwasher or the like, may provide for an appliance body 12, for example, having a generally rectangular prismatic body form constructed of enameled steel or molded thermoplastic. The appliance body 12, for example in the case of a depicted dryer, may provide for a front door 14 openable to expose an internal dryer basket 16 that may be driven by a motor 18 also powering a blower (not shown) providing airflow over electrical heater 20 or the like.

The appliance body 12 may, for example, present a planar horizontal upper surface 22 for receiving, at its rear edge, the substantially horizontal planar lower surface 24 of a bottom of a first console 26. A front surface 28 of the console may present various user controls 30, for example, including a cycle timer control knob 32, text or graphic display 34, indicator lights 35, and electrical switches 36 in the form of pushbuttons, toggle switches, or rotary dial switches of a type known in the art.

Alternatively, a second console 38 having a similar construction to first console 26 may be received by the planar horizontal upper surface 22 of the appliance body 12, the second console 38 differing from the first console 26, however, in that it provides a different set of user controls 30′ including, for example, a cycle timer control knob 32′ and user selector buttons 36′. These user controls 30′ will implement different functions and capabilities for the appliance 10 than the user controls 30.

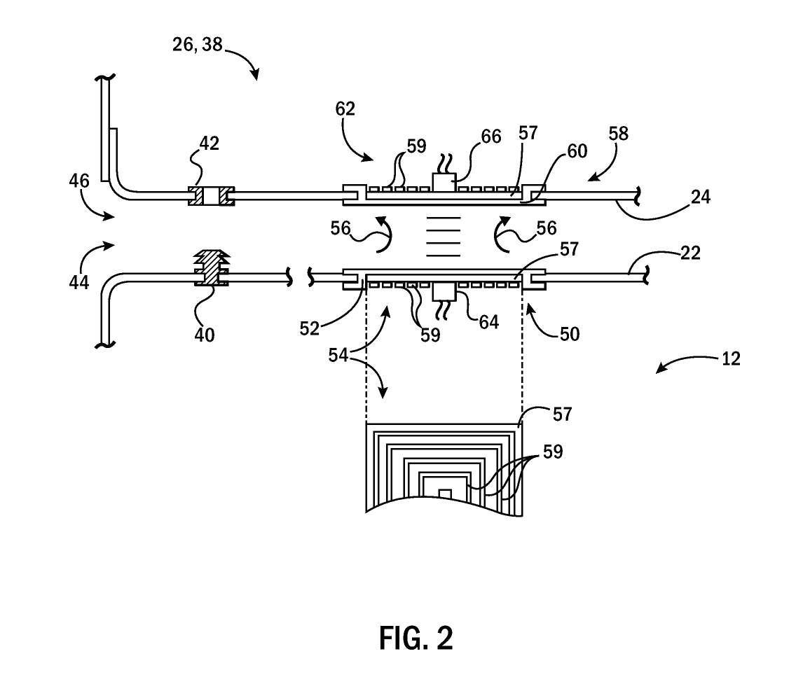

Referring now to FIGS. 1 and 2, the planar horizontal upper surface 22 near the location of attachment of the console 26 or 38 may provide for mechanical interlock elements 44, for example barb elements 40, that may be received by corresponding mechanical interlock elements 46, for example barb sockets 42, in the horizontal planar lower surface 24 of the console 26 or 38. These interlock elements 44 and 46 provide mechanical connection between the appliance body 12 and the console 26 or 38 and are designed to be installed simply by unskilled labor at a retail environment.

The sheet metal of the planar horizontal upper surface 22 of the appliance body 12 may be pierced by an opening 50 position in an area to be covered by the console 26 or 38. This opening 50 may be covered with a nonferrous or plastic cover 52 that may support a primary coil 54 positioned adjacent to an underside of the cover 52 to provide a substantially vertical magnetic flux 56 passing upward through the planar horizontal upper surface 22. The primary coil 54 may be implemented on a printed circuit board 57 as a spiral of conductive traces 59 to form a so-called “fingerprint” coil. In the event that the appliance body 12 is a plastic material, the primary coil 54 may be positioned in a similar location without the need to create the opening 50. Generally the primary coil 54 will be sealed against water ingress and will be separated from user contact at the upper surface 22 by an insulating material being either the a portion of the cover 52 or continuation of a plastic upper surface 22.

A corresponding opening 58 may be cut in the horizontal planar lower surface 24 of the console 26 or 38 to align with the opening 50 in the planar horizontal upper surface 22 of the appliance body 12 when the two are mechanically connected. A cover 60 similar to cover 52 may cover the opening 58 to which may be attached a secondary coil 62 of substantially identical configuration as the primary coil 54 to receive the magnetic flux 56 to induce a current within the secondary coil 62. While primary coil 54 and secondary coil 62 are shown implemented on a printed circuit board, other coil configurations including windings on magnetic cores and the like may be used. Generally the secondary coil 62 will also be protected from the ingress of moisture and will provide an electrically insulating layer between it and the surface 22. In the event that the appliance body 12 is a plastic material, the opening 58 and cover 60 may be dispensed with.

Within the primary coil 54 on the lower side of the cover 52 may be positioned a wireless transceiver 64, for example, an infrared photodetector/photoemitter pair or a radio transceiver such as a Zigbee or Bluetooth radio. A corresponding transceiver 66 may be centered within the secondary coil 62 on the upper side of the cover 60 to intercommunicate with transceiver 64 for the exchange of data therebetween. As will be understood from the description below, when the console 26 or 38 is assembled against the appliance body 12 by engaging interlock elements 44 and 46, cover 52 will abut cover 60 to provide for power exchange between coils 54 and 62 and data exchange between transceiver 64 and 66 without direct electrical connection, the communicating elements being separated by the insulating material of the covers 52 and 60. In an alternative embodiment the transceiver 64 and 66 may make use of the coupling between primary and secondary coils 54 and 62 to convey data therebetween in the manner of antennas.

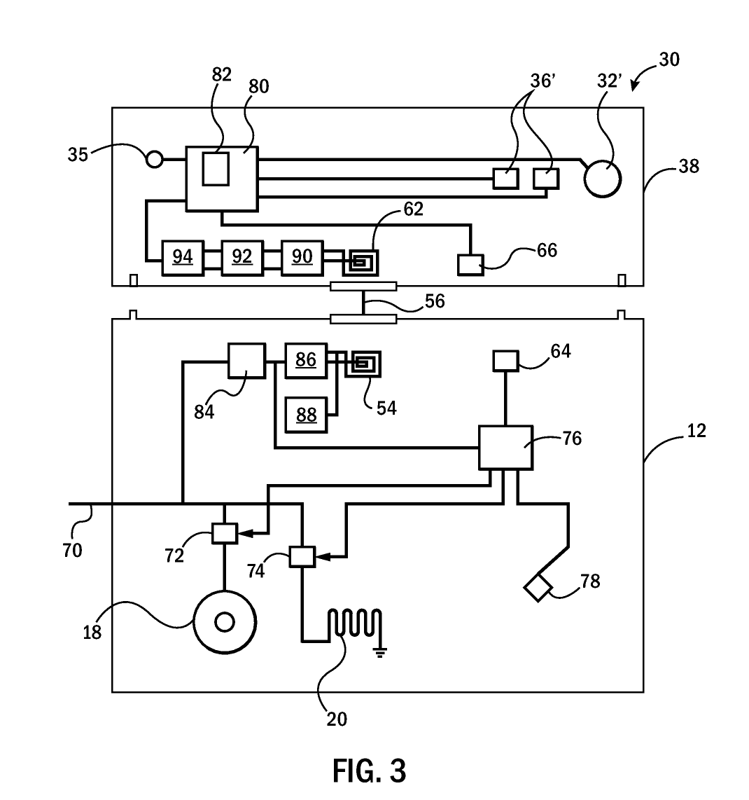

Referring now to FIG. 3, the appliance body 12 may admit an electrical cord 70 which may communicate with control relays or thyristors 72 and 74 to provide power to the motor 18 or electrical heater 20 upon signal from a control board 76 positioned in the appliance body. The control board 76 may likewise receive signals from a sensor 78, for example, a humidity or temperature sensor or door switch. The control board 76 may in turn communicate with transceiver 64 to provide data from the sensor 78 to transceiver 66 which may communicate with a console control board 80. The control board 76 may for example include a microcontroller of the type well known in the art executing a stored program to read data from digital or analog input and provide signals from digital or analog outputs. Console control board 80 may also read data from user controls 30 including control knob 32 and controls 36. Based on the data collected and a stored program 82 executed by a processor on the control board 80, control board 80 may provide signals to transceiver 66 to be received by transceiver 64 to control the solid-state switches 72 and 74 and hence the operation of motor 18 and heater 20.

Power 70 may also be provided to a power supply 84 in the appliance body 12, for example, producing a source of DC power that is provided to the control board 76 and to wireless power oscillator 86, the latter which is connected to primary coil 54 to produce an oscillating magnetic field 56 that may induce power in coil 62. A power control module 88 may optionally connect to primary coil 54 to detect the proximity of coil 62 (for example by the voltage on primary coil 54) and control the oscillator 86 to reduce power from the oscillator 86 when coil 62 is not present to prevent overheating of primary coil 54 and the unnecessary use of power.

The secondary coil 62 may be connected to a rectifier unit 90 converting the induced AC waveform received by secondary coil 62 into direct current power which is provided to a filter 92 and ultimately to a power regulator 94 providing power to control board 80 and possibly to controls 36′ and 32′, for example, to power lights or the like. It will be understood therefore that electrical power to operate the electronics of the console 38 may thereby be provided without direct electrical connections.

The transceiver 64 may likewise communicate data from the control unit 76 through transceiver 66 to control unit 80 for example to send information from the humidity sensor 78 or other sensor systems. This information may be used by the control unit 80 to provide user output for example through lamp 35 or to implement control strategies for example feedback control in which the receive signals are used to affect control signals to the appliance. These control signals may be sent through transducer 66 from the controller 83 receipt by transceiver 64 in the control 76 to implement the control of the switches 72 and 74 for example.

The console 26 may be substantially identical to the console 38 described above with the exception of different user controls 30 and a different program 82 that may implement different functionality for example different drying cycles or washing cycles. The implementation of different functionality may be performed with identical user controls or different user controls reflecting the differences in obtainable functionality.

Thus it will be appreciated that different consoles 38 or 26 may be applied to the appliance body 12 to implement different functionality. For functionality that requires different actuating elements, for example motor 18 and heater 20, or different sensing elements, for example humidity sensor 78, a limited set of different appliance bodies may be stocked to be mixed and matched with the consoles 26 and 38 to provide for a wide variety of different styles and models.

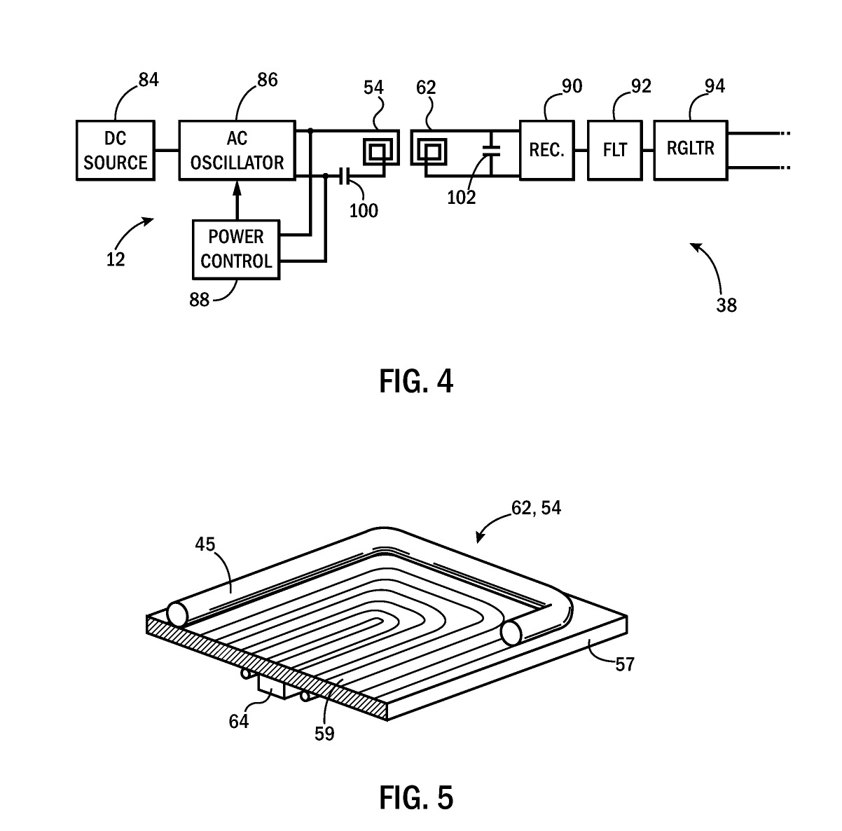

Referring now to FIG. 4, the primary coil 54 may receive an alternating current signal from an oscillator 86 synthesizing that signal from a DC source 84, for example, of twenty-four volts available in the appliance 10 from a conventional DC power supply of the type well known in the art. Generally, the frequency of oscillation will be substantially above that of line current (i.e. 60 Hz) or rectified line current (e.g. 120 Hz) and may be, for example, 350 to 700 kHz to provide for more efficient transmission. Such higher frequencies also permit filtering with smaller capacitors.

The output of the oscillator 86 may be provided to a resonant circuit formed by the inductance of the primary coil 54 and a capacitor 100 together tuned to a resonant frequency substantially equal to the fundamental frequency of the oscillator 86. The circuitry to produce the AC oscillator 86 can be placed on the same printed circuit board holding the primary coil 54. Higher frequency operation is further enhanced by elimination of a magnet core of ferromagnetic material permitting more efficient high-frequency operation by the elimination of eddy current losses.

The secondary coil 62 may also be tuned to the resonant frequency of the primary coil 54, for example, by a tuning capacitor 102 to efficiently inductively couple to the primary coil 54 thereby providing an AC signal to a rectifier 90 and filter 92 to provide DC power to a regulator 94. The regulator 94 may be, for example, a boost or buck converter that may provide a controlled voltage or current to the console circuitry.

The primary coil 54 may also be attached to power control circuitry 88 sensing the presence of a console 26 or 38 and its corresponding coil 62 near the primary coil 54 by sensing the load of secondary coil 62, for example, as a decrease in voltage on primary coil 54, and may communicate with the oscillator 86 to turn the oscillator 86 off when there is no console present, thus conserving power. The power control circuitry 88 may periodically turn the oscillator 86 on to check for a console 26 or 38, in a place adjacent to that primary coil 54.

Referring now to FIG. 9, in either embodiment, the primary coil 54 and a secondary coil 64 may be fabricated on a printed circuit board using traces 59 on a printed circuit board substrate 57, for example a glass epoxy substrate material. The traces 59 may be formed in a spiral pattern to eliminate cross over in a single dimension of the trace or may be concentric circles connected by vias and other layers of the circuit board or the like. The primary coil 54 may be provided with increased current capacity by soldering a metal wire form 45 (for example a copper wire) to the trace to be supported and constrained thereby. Other components (to be described below) with respect to each of the coils may be soldered on similar traces on the opposite side of the printed circuit board substrate 57 to provide a compact, robust and integrated assembly. The primary coil 54 or secondary coil 64 may be, for example, planar in configuration passing in a rectangular helix to form a so-called “fingerprint” coil substantially within a plane of the printed circuit board. The primary coil 54 or power-receiving coil 63 may be covered from user contact or water ingress by non-ferromagnetic thermoplastic material of the surface 22 of the appliance or the cover 52.

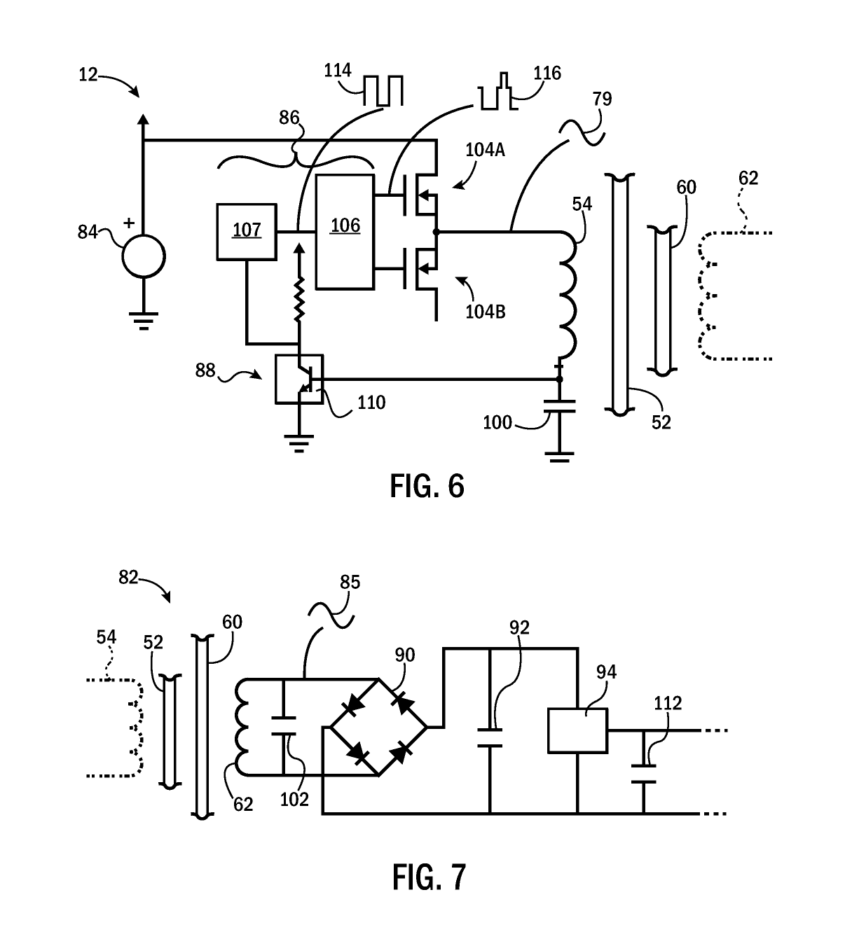

Referring now to FIG. 6, circuitry associated with the primary coil 54 may include a bi-stable multi-vibrator 107 (for example a 555 timer) using a capacitive/resistive network and comparators to provide a substantially 50% duty cycle waveform 114 at the desired resonant frequency to a half bridge driver 106. The half bridge driver 106 may drive transistors 104a and 104b connected at a common point to primary coil 54 and have their other leads connected to power and ground respectively. For this purpose, the half bridge driver 106 may provide two modified waveforms 116 (only one shown for clarity) at 180° phase difference providing a switching of the transistors 104a and 104b alternately on and off while ensuring no overlap. The resulting switched signal may be applied to a resonant circuit formed from the primary coil 54 and capacitor 100 connected in series to ground to provide a substantially sinusoidal current flow 79 at the desired frequency. A junction between the primary coil 54 and capacitor 100 may be monitored by a threshold-detecting amplifier 110 that may activate the reset line of the oscillator 107 turning the oscillator 107 off when voltage rises beyond a certain point indicating the absence of an adjacent console 26 and 38.

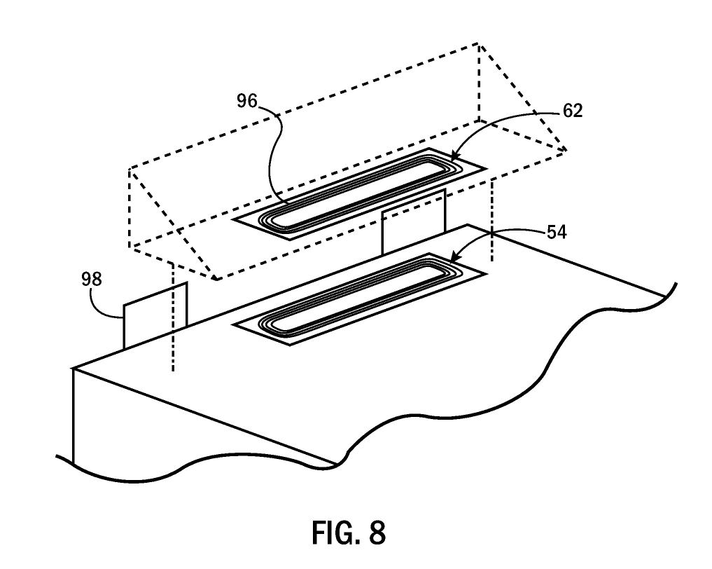

Referring now to FIG. 7, the receiving circuitry may attach to the secondary coil 64 to also provide for a parallel resonant tuned circuit by means of capacitor 102 connected across secondary coil 64 and providing, with the inductance of secondary coil 64, a center resonant frequency substantially equal to the center resonant frequency of the circuit of primary coil 54. The resulting sinusoidal received waveform 85 may be rectified by a full wave rectifier 90 and filtered by a filter 92 comprising a shunting capacitor to provide unregulated direct current to the voltage regulator 94. A subsequent filter capacitor 112 may be provided to further filter the output of the regulator 94.

Referring now to FIG. 8 in an alternative embodiment, the primary coil 54 and secondary coil 62 may be constructed of discrete windings of electrical wire 96 having a center conductor and outer insulating coating, the electrical wire 96 formed in rectangular loops to provide for a higher winding density and greater area than may be practical with the printed circuit board design. In addition or alternatively, the barb elements 40 used to attach the consoles 26 or 38 to the appliance body 12, may be replaced with metal plates 98 attached to the consoles 26 or 38 and the appliance body 12 at their rear surfaces by machines screws (not shown) or the like.

Various features of the invention are set forth in the following claims. It should be understood that the invention is not limited in its application to the details of construction and arrangements of the components set forth herein. The invention is capable of other embodiments and of being practiced or carried out in various ways. Variations and modifications of the foregoing are within the scope of the present invention. It also being understood that the invention disclosed and defined herein extends to all alternative combinations of two or more of the individual features mentioned or evident from the text and/or drawings. All of these different combinations constitute various alternative aspects of the present invention. The embodiments described herein explain the best modes known for practicing the invention and will enable others skilled in the art to utilize the invention.

What is claimed is:

1. An appliance system comprising:
an appliance body providing a cabinet housing with at least one of electrical actuators and electrical sensors for implementing a function of the appliance;
a first and second appliance console providing different user accessible controls implementing at least some different appliance functions, the appliance consoles interchangeably attaching to the appliance body;
wherein the appliance body supports at least one primary coil attached proximate to a location of an appliance console when an appliance console is attached to the appliance body, the primary coil attached to driving circuitry providing an oscillating magnetic field passing from the appliance body;
and wherein the first and second appliance console each support at least one secondary coil attached proximate to the primary coil of the appliance body when the appliance console is attached to the appliance body, the secondary coils being electrically connected to receiving circuitry to rectify an alternating current signal induced in the secondary coil by the primary coil to provide power to the appliance console.

2. The appliance system of claim 1 further including a wireless transceiver pair positioned one in the console and one in the appliance body for transmitting and receiving data respectively between at least one of the user accessible control and one of sensors and actuators in the appliance body.

3. The appliance system of claim 1 wherein the user accessible controls are selected from the group consisting of: manually operated electrical switches and visual displays.

4. The appliance system of claim 1 wherein the primary and secondary coils are planar coils having conductors confined substantially each to a single plane.

5. The appliance system of claim 4 wherein the primary and secondary coils are formed at least in part as traces in a printed circuit board.

6. The appliance system of claim 1 further including a sensor controlling power transmitted from the primary coil according to whether a secondary coil is positioned nearby.

7. The appliance system of claim 1 wherein the primary and secondary coils are separated from user contact by an electrical insulator when the appliance console is attached to the appliance body.

8. An appliance console attachable to an appliance body, the appliance body providing a cabinet housing with at least one electrical actuator or electrical sensor for implementing a function of the appliance, the appliance console providing user accessible controls for the function when attached to the appliance body, the appliance console including an electrical coil positioned in the appliance console to be proximate to a corresponding electrical coil in the appliance body when at a provide electromagnetic coupling between the electrical coils when the appliance console is attached to the appliance body for communicating electrical power from the appliance body to the appliance console by inductive coupling.

9. The appliance console of claim 8 wherein the electrical coil positioned in the appliance console is covered by an electrical insulator before and after the appliance console is attached to the appliance body.

10. The appliance console of claim 8 further including a wireless transceiver positioned in the appliance console for communicating data with a corresponding wireless transceiver positioned in the appliance body between at least one of the user accessible control and one of sensors and actuators in the appliance body.

11. The appliance system of claim 8 wherein the user accessible controls are selected from the group consisting of: manually operated electrical switches and visual displays.

12. The appliance system of claim 8 wherein the primary and secondary coils are planar coils having conductors confined substantially each to a single plane.

13. The appliance system of claim 12 wherein the primary and secondary coils are formed at least in part as traces in a printed circuit board.

14. A method of managing appliance inventory comprising the steps of:
(a) stocking a first set of appliance bodies each providing a cabinet housing with at least one of electrical actuators and electrical sensors for implementing a function of the appliance, the cabinet supporting at least one primary coil attached proximate to a location of an appliance console, the primary coil attached to driving circuitry providing an oscillating magnetic field passing from the appliance body, the appliance bodies further including a wireless data receiver communicating with the primary coil;
(b) stocking separate sets of a first and second appliance console providing for user accessible controls implementing at least some different appliance functions, the appliance console supporting at least one secondary coil attached proximate to the primary coil of the appliance body when the console is mounted on the appliance body, the secondary coils attached to receiving circuitry to rectify an alternating current signal induced in the secondary coil by the primary coil to provide electrical output providing power to the user accessible controls; the first and second appliance consoles further including a wireless data transmitter connected to the secondary coil; and
(c) selectively attaching one of the first and second consoles to an appliance housing to determine a function of a resulting appliance.
